(19) United States
(12) Patent Application Publication
(10) Pub. No.: US 2007/0231654 A1
(43) Pub. Date: Oct. 4, 2007

(54) Process of producing sulfonic group-containing substituted polyacetylene membrane, membrane obtained thereby and application thereof

(75) Inventors: Hitoshi Ito, Kanagawa (JP); Eiichi Akiyama, Kanagawa (JP); Hiroshi Yokota, Kanagawa (JP); Kazuyoshi Takedai, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EBARA CORPORATION, Tokyo (JP)

(21) Appl. No.: 11/730,008

(22) Filed: Mar. 29, 2007

(30) Foreign Application Priority Data
Mar. 31, 2006 (JP) 2006-099390

(51) Int. Cl. H01M 8/10; C08J 5/22

(52) U.S. Cl. 429/33; 521/27

(57) ABSTRACT

A process of producing a substituted polyacetylene electrolyte membrane which is a solid electrolyte membrane having a sulfonic group uniformly introduced thereinto, with its electrode assembly being useful as an electrochemical device or a fuel cell and an electrolyte membrane using the same are provided.
A process of producing a sulfonic group-containing substituted polyacetylene membrane, which includes molding a substituted polyacetylene containing a repeating unit represented by the following formula (1) into a membrane state and bringing the molding into contact with a sulfonating agent to achieve sulfonation and a substituted polyacetylene membrane which is produced by the subject production process and in which the sulfonic group is uniformly distributed in a membrane thickness direction.

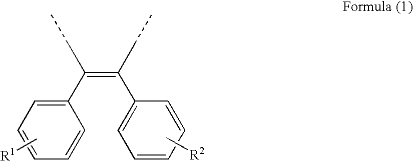

In the formula (1), either one or all of R¹ and R² represent a silyl group represented by the following formula (2); and the remainder represents hydrogen, a hydroxyl group, an alkyl group or an alkoxy group each having from 1 to 8 carbon atoms, a t-butyldimethylsilyloxy group, an acetyloxy group, or a group represented by the following formula (3).

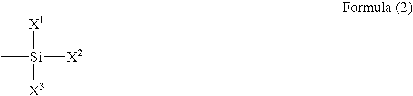

In the formula (2), X¹, X² and X³ each independently represents a linear or branched alkyl group having from 1 to 6 carbon atoms.

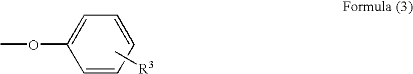

In the formula (3), R³ represents hydrogen, a hydroxyl group, an alkyl group or an alkoxy group each having from 1 to 8 carbon atoms, a trimethylsilyl group, a t-butyldimethylsilyloxy group, an acetyloxy group, or a group represented by the formula (2).

### BACKGROUND OF THE INVENTION

1. Field of the Invention

The present invention relates to a process of producing a sulfonic group-containing substituted polyacetylene membrane as an electrolyte and an electrolyte membrane which are suitably used in various electrochemical devices such as a fuel cell, a secondary battery, a humidity sensor, an ion sensor, a gas sensor, and a desiccant and to an electrochemical device and a fuel cell using the same.

2. Description of the Related Art

An electrolyte and an electrolyte membrane are used in electrochemical devices such as a fuel cell, a secondary battery, a humidity sensor, an ion sensor, a gas sensor, and a desiccant and are each a member which influences most largely a performance of such a device. Since acid dissociable functional group-containing fluorocarbon based polymers exhibit excellent performances in electrolyte characteristics, mechanical characteristics, chemical stability, and so on as an electrolyte material constituting such a member, they are developed over a wide range of applications.

Besides fluorocarbon based polymers, aromatic polymer electrolytes are mainly developed eagerly. As a main chain of aromatic polymers excellent in heat resistance, mechanical characteristic and chemical stability, various main chains, for example, polybenzimidazoles, polysulfones, polyetheretherketones, polyamides, and polyimides are utilized. On the other hand, recently, electrolyte membranes of a new type such as those resulting from introduction of an acid dissociable functional group into a fullerene which is watched as a functional material and further molding with a polymer binder and conjugated polymer electrolytes are developed.

On the other hand, polyacetylenes have a structure in which when acetylene is subjected to coordination polymerization by using a transition metal, a double bond and a single bond are alternately connected in a main chain. In a polyacetylene in which this double bond is bound by the trans conformation, since a π-electron of the main chain conjugates, it exhibits semiconductor properties. Also, it is known that when such a polyacetylene is subjected to chemical doping, it exhibits metallic gloss and realizes conductivity equal to that of a metal (see H. Shirakawa, T. Masuda and K. Takeda, The Chemistry of triple-bonded functional groups, Chapter 17, pp. 945-1016, Ed. By S. Patai, John Wiley & Sons, Chichester, 2004).

Furthermore, in polyacetylenes resulting from polymerization of a mono-substituted acetylene derivative, various functional substituents can be introduced into a side chain of the polyacetylene. Accordingly, such polyacetylenes are watched as a new functional material such as conductive polyacetylenes having liquid crystal properties or photo functionality imparted thereto and polyacetylene electrolytes having a sulfonic group or phosphonic group introduced thereinto (see K. Akagi, T. Kadokura and H. Shirakawa, Polymer, 1992, 33, 4058, and H. Onouchi, D. Kashiwagi, K. Hayashi, K. Maeda and E. Yashima, Macromolecules, 2004, 37, 5495-5503).

Also, polyacetylenes resulting from polymerization of a di-substituted acetylene derivative are reported, too. For example, a polyacetylene membrane into which a bulky substituent such as 1-trimethylsilyl-1-propine has been introduced is expected to be applied to an oxygen enrichment membrane or the like. It is also reported that by coordination polymerizing a diphenylacetylene derivative, a polymer having a high molecular weight which is rich in the cis conformation is obtained, along with gas permeability of a membrane using the same (see JP-A-2002-322293, K. Nagai, T. Masuda, T. Nakagawa, B. D. Freeman and I. Pinnau, Prog. Polym. Sci., 2001, 26, 721-798 and T. Masuda, M. Teraguchiand R. Nomura, Am. Chem. Soc. Sym. Ser., 1999, 733, 28-37).

Also, a method of preparing a solid polymer electrolyte membrane by introducing an ion dissociation group into a substituted polyacetylene is described (see JP-A-2004-296141). The described sulfonation method includes mainly two ways such as a method in which a polymerized polyacetylene is brought into contact with a sulfonating agent such as chlorosulfonic acid and concentrated sulfuric acid and then fabricated into a membrane; and a method in which a sulfonic group-containing monomer is polymerized and then fabricated into a membrane. However, in our studies, in the case where a sulfonating agent is added to a polymer solution to perform sulfonation, the resulting polymer became insoluble in usual solvents such as N,N-dimethyl sulfoxide, N,N-dimethylacetamide, water, methanol, acetone, and ethyl acetate so that fabrication into a membrane was difficult. Furthermore, it is supposed that when the amount of introduction of a sulfonic group is increased, though the resulting polymer becomes soluble in water so that fabrication into a membrane is possible, it is difficult to apply the membrane as a solid electrolyte, especially a solid electrolyte membrane for fuel cell. Furthermore, even in the case of polymerizing or copolymerizing a sulfonic group-containing monomer, the resulting polymer has a similar structure, and as described previously, it is supposed that the polymer is insoluble in solvents. Also, there is enumerated a method in which a sulfonic group is protected with an amine or the like to form a sulfonamide, which is then polymerized and hydrolyzed. However, in general, it is known that a sulfonamide is eliminated only by a strong acid such as hydrogen bromide and perchloric acid or a strong base such as sodium naphthalenide and sodium anthracenide. In the case of employing such a reaction, there is a possibility that side reactions such as breakage of a main chain are generated. Therefore, it cannot be said that this method is preferable (see T. W. Greene, P. G. M. Wuts, PROTECTIVE GROUPS IN ORGANIC SYNTHESIS, 3rd ed., pp. 605, JOHN WILY & SONS, New York, 1999).

Though the above-enumerated acid dissociable functional group-containing fluorocarbon based polymer electrolytes are excellent in electrolyte characteristics, workability, mechanical strength and chemical stability, they involved such problems that the heat resistance is not sufficient and that the raw materials and manufacturing costs are expensive. Also, since such an acid dissociable functional group-containing fluorocarbon based polymer electrolyte contains a fluorine atom in a structure thereof, there is a fear that during the manufacturing process or disposal of a product, the release of a fluorine ion or a fluoride into the environment influences living bodies or applies a load to the environment. In such a social side view, the development of a hydrocarbon based polymer electrolyte in place of the fluorocarbon based polymer electrolyte is eagerly carried out. However, all of the aromatic polymer electrolytes, the fullerene-containing electrolytes and the conjugated polymer electrolytes involved such problems that the mechanical strength is low and that the workability is poor.

On the other hand, with respect to the polyacetylene derivatives, there have been made reports regarding electron conductivity, ionic conductivity and so on. Also, there have been known substituted polyacetylene electrolytes into which an ion exchange group has been introduced as described previously. However, as described previously, it could not be said that in the case where an ion exchange group to be introduced is a sulfonic group, its sulfonation method and membrane fabrication method are a sufficient technology.

The present inventors thought that when a substituted polyacetylene is fabricated into a membrane and then sulfonated, the foregoing problem of insolubilization can be overcome. However, it has become clear that when a polydiphenylacetylene membrane is dipped in a sulfonating agent such as concentrated sulfuric acid to achieve sulfonation, a sulfonic group is not introduced into the inside of the membrane so that the sulfonic group cannot be uniformly introduced in a membrane thickness direction.

### SUMMARY OF THE INVENTION

In view of the foregoing known facts, for the purpose of providing a solid electrolyte membrane which exhibits electrolyte characteristics enough for use in an electrochemical device, has sufficient heat resistance and mechanical strength depending upon applications, does not contain a halogen element (such as fluorine) having a large load to the environment and is excellent in membrane fabrication properties and workability, an electrode assembly and an electrochemical device and a fuel cell using the same, an object of the invention is to provide a process of producing a solid electrolyte membrane having a sulfonic group uniformly introduced thereinto, and preferably a sulfonic group-containing substituted polyacetylene electrolyte membrane having an ion exchange capacity larger than that of the related art and an electrolyte membrane obtained thereby.

In order to solve the foregoing problems, the invention is concerned with a process of producing a sulfonic group-containing substituted polyacetylene membrane, which includes molding a substituted polyacetylene containing a repeating unit represented by the following formula (1) into a membrane state and bringing the molding into contact with a sulfonating agent to achieve sulfonation.

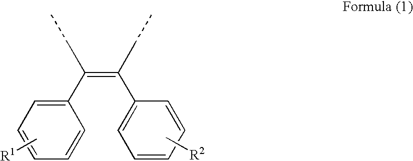

In the formula (1), either one or all of R¹ and R² represent a silyl group represented by the following formula (2); and the remainder represents hydrogen, a hydroxyl group, an alkyl group or an alkoxy group each having from 1 to 8 carbon atoms, a t-butyldimethylsilyloxy group, an acetyloxy group, or a group represented by the following formula (3).

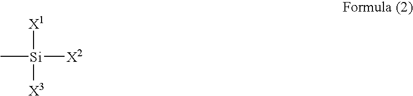

In the formula (2), X¹, X² and X³ each independently represents a linear or branched alkyl group having from 1 to 6 carbon atoms.

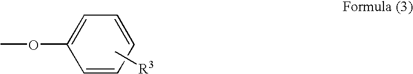

In the formula (3), R³ represents hydrogen, a hydroxyl group, an alkyl group or an alkoxy group each having from 1 to 8 carbon atoms, a trimethylsilyl group, a t-butyldimethylsilyloxy group, an acetyloxy group, or a group represented by the formula (2).

At that time, when easiness of availability of a starting raw material which is used in the monomer synthesis and a degree of polymerization or solubility in an organic solvent of the substituted polyacetylene are taken into consideration, it is preferable that in the formula (2), X¹, X² and X³ each independently represents an alkyl group having from 1 to 4 carbon atoms; and it is more preferable that the group represented by the formula (2) is a trimethylsilyl group. Also, the sulfonating agent which is used at that time is especially preferably any one member selected from concentrated sulfuric acid, a mixed solution of concentrated sulfuric acid and a solvent, fuming sulfuric acid, sulfur trioxide-dioxane, sulfur trioxide-pyridine, chlorosulfonic acid, and sulfurous acid, or a combination of a plurality thereof.

Also, the invention is concerned with a sulfonic group-containing substituted polyacetylene membrane which is produced by the foregoing production process and in which a sulfonic group is uniformly distributed in a membrane thickness direction such that the sulfonic group is introduced into the inside of the membrane, therefore the sulfonic group of the sulfonic group-containing substituted polyacetylene membrane is uniformly distributed in a membrane thickness direction. At that time, as an index to exhibit the matter that a sulfonic group is uniformly distributed in a membrane thickness direction, for example, a characteristic X-ray (SKa) intensity ratio derived from a sulfur atom constituting a sulfonic group as measured by SEM-EDS (Scanning Electron Microscope-Energy Dispersive X-ray Spectrometer) can be employed, and an intensity of a central part of the membrane is preferably 70% or more, more preferably 80% or more, and most preferably 90% or more of a maximum value of SKa within the measurement range. Moreover, in the sulfonic group-containing substituted polyacetylene membrane produced by the foregoing production process, it is especially preferable that an ion exchange capacity is from 2.0 to 3.5 meq/g.

As a preferred application of the foregoing sulfonic group-containing substituted polyacetylene membrane obtained by the invention, there is enumerated a substituted polyacetylene membrane/electrode assembly resulting from imparting an electrode to this sulfonic group-containing substituted polyacetylene membrane; and this substituted polyacetylene membrane/electrode assembly can be suitably used for electrochemical devices. As the electrochemical device, various electrochemical devices such as a fuel cell, a secondary battery, a humidity sensor, an ion sensor, a gas sensor, and a desiccant can be suitably used, with a fuel cell being especially preferable for use.

In the invention, in the contact with concentrated sulfuric acid which is a known sulfonation method, it is estimated that since a viscosity of concentrated sulfuric acid is relatively high, the concentrated sulfuric acid does not penetrate into the inside of the membrane so that the sulfonation does not proceed completely. Based on the results thereof, the present inventors thought that so far as the membrane is a membrane in which sulfuric acid (sulfonating agent) is easy to penetrate into the inside thereof, even the inside of the membrane can be readily sulfonated and then attempted to use a membrane having a large free volume as such a structure.

For example, it is known that a trimethylsilyl group-containing polyacetylene membrane has a large free volume due to an influence of the bulky trimethylsilyl group (see T. Masuda, H. Tachimori, Pure Appl. Chem., 1994, A31, 1675-1690). Furthermore, there is known a method in which a trimethylsilyl group-containing aromatic ring is sulfonated with sulfur trioxide-dioxane or sulfur trioxide due to a displacement reaction with the trimethylsilyl group (see Peter G. M. Wuts, Katherun E. Wilson, Synthesis, 1998, 1593-1595 and R. W. Bott, C. Eaborn, Tadashi Hashimoto, J. Organometallic. Chem., 1965, 3, 442-427).

By applying such knowledge, the present inventors have proposed means for solving the problems of the invention, leading to accomplishment of the invention. However, there is present no example to apply such knowledge to synthesis of a polymer electrolyte and further to sulfonation of a substituted polyacetylene. Furthermore, the uniformity of introduction of a sulfonic group regarding sulfonation of a membrane is neither taught nor suggested in the foregoing documents.

That is, the invention is concerned with a technology in which a silyl group-containing substituted polyacetylene obtained by, for example, coordination polymerization of an acetylene monomer containing a bulky linear or branched silicon-containing substituent having from 1 to 6 carbon atoms (for example, a silyl group) is used and fabricated into a membrane, which is then brought into contact with a sulfonating agent such as a strong acid (for example, concentrated sulfuric acid), a mixed solution of concentrated sulfuric acid and a solvent, sulfur trioxide, and sulfur trioxide-dioxane, thereby penetrating the sulfonating agent into the inside of the membrane; and following elimination of the silyl group, a sulfonic group is uniformly introduced in a membrane thickness direction.

Incidentally, in the invention, what the introduced sulfonic group is uniformly introduced into the inside of the membrane means that in the case where the distribution of the sulfonic group (based on a sulfur atom S) in a membrane thickness direction is examined by SEM-EDS, an intensity of characteristic X-ray of S (SKa) in a central part of the membrane is preferably 70% or more, more preferably 80% or more, and most preferably 90% or more of a maximum value of SKa within the measurement range.

Furthermore, since the sulfonic group-containing substituted polyacetylene membrane obtained by the process of the invention contains uniformly a sulfonic group in a membrane thickness direction, it is a sulfonic group-containing substituted polyacetylene membrane which different from substituted polyacetylene electrolyte membranes prepared by the related-art technologies, even when an ion exchange capacity is 2.0 meq/g or more, has a sufficient membrane strength depending upon a condition and is not dissolved in water or a methanol aqueous solution. However, when the ion exchange capacity exceeds 3.5 meq/g, there may be a possibility that the sulfonic group-containing substituted polyacetylene membrane is dissolved in water or a methanol aqueous solution. In such a substituted polyacetylene membrane, since the sulfonic group is uniformly introduced and the ion exchange capacity is large depending upon a condition, this substituted polyacetylene membrane is a solid polymer electrolyte membrane excellent in ionic conductivity of a proton (hydrogen ion), a lithium ion, or the like. In addition, in the case where the polymer electrolyte membrane has a large ion exchange capacity as described previously, it can be expected that the polymer electrolyte membrane has high proton conductivity even in a low humidity state. As a matter of course, since a halogen element is not introduced in a chemical structure to be constituted by a covalent bond, it is expected that a load to the environment related to the halogen element is small.

According to the invention, it is possible to introduce uniformly a sulfonic group in a membrane thickness direction and to synthesize a sulfonic group-containing substituted polyacetylene membrane having an ion exchange capacity of from 2.0 to 3.5 meq/g, which has been unable to be synthesized so far depending upon a condition. Such a sulfonic group-containing substituted polyacetylene membrane can be used as a solid polymer electrolyte membrane excellent in proton conductivity and ionic conductivity. Since such a sulfonic group-containing substituted polyacetylene membrane has a mechanical strength enough for use as an electrochemical device, is excellent in heat resistance and does not contain a halogen atom which has been introduced due to a covalent bond in a chemical structure thereof, it is expected that a load to the environment during the manufacture or disposal. Accordingly, such a sulfonic group-containing substituted polyacetylene membrane is suitable for use of electrochemical devices such as a fuel cell and an ion sensor.

### BRIEF DESCRIPTION OF THE DRAWINGS

FIG. 1 is a graph to show SEM-EDS measurement results of an SB-2 membrane.

FIG. 2 is a graph to show SEM-EDS measurement results of an SA-1 membrane.

FIG. 3 is a graph to show SEM-EDS measurement results of an SA-2 membrane.

FIG. 4 is a graph to show SEM-EDS measurement results of an SC-2 membrane.

FIG. 5 is a graph to show SEM-EDS measurement results of an SC-3 membrane.

FIG. 6 is a graph to show SEM-EDS measurement results of an SD-1 membrane.

FIG. 7 is a graph to show SEM-EDS measurement results of an SD-2 membrane.

### DETAILED DESCRIPTION OF THE INVENTION

The invention is hereunder described in more detail. The substituted polyacetylene which is used in the invention is not particularly limited so far as it contains a structure of the formula (1) in a molecular structure thereof and may be a homopolymer resulting from polymerizing one kind of an acetylene derivative or a copolymer resulting from polymerizing two or more kinds of acetylene derivatives. The acetylene derivative can be synthesized from a halogenated arylene compound containing a desired silyl group and an acetylene compound such as phenylacetylene by employing a known method such as a Sonogashira-Hagiwara coupling method. Though the substituted polyacetylene is obtained by heating the subject acetylene derivative in a dehydrating solvent by using a catalyst of a transition metal (for example, Nb, Ta, Mo, and W) or such a catalyst and a co-catalyst (for example, tetrabutyltin), all of known polymerization methods can be employed. A molecular weight of the substituted polyacetylene largely influences the heat resistance and mechanical strength of the electrolyte membrane. When the molecular weight is too low, a lowering in the heat resistance or mechanical strength is brought, whereas when it is too high, a lowering in the solubility or an increase in the solvent amount during the membrane fabrication is brought. Accordingly, it is preferred to use a substituted polyacetylene having a molecular weight in the range of from approximately 10,000 to 10,000,000, and more desirably from 50,000 to 5,000,000.

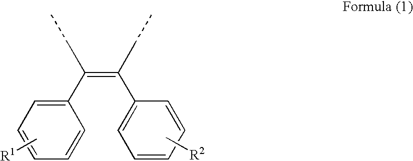

In the formula (1), either one or all of R¹ and R² represent a silyl group represented by the following formula (2); and the remainder represents hydrogen, a hydroxyl group, an alkyl group or an alkoxy group each having from 1 to 8 carbon atoms, a t-butyldimethylsilyloxy group, an acetyloxy group, or a group represented by the following formula (3).

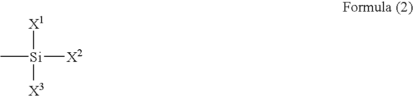

In the formula (2), X¹, X² and X³ each independently represents a linear or branched alkyl group having from 1 to 6 carbon atoms.

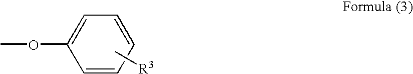

In the formula (3), R³ represents hydrogen, a hydroxyl group, an alkyl group or an alkoxy group each having from 1 to 8 carbon atoms, a trimethylsilyl group, a t-butyldimethylsilyloxy group, an acetyloxy group, or a group represented by the formula (2).

In the case where the substituents R¹, R² and R³ on the aromatic ring each represents an alkyl group or an alkoxy group, specific examples thereof include a methyl group, an ethyl group, an n-propyl group, an isopropyl group, a cyclopropyl group, an n-butyl group, a t-butyl group, a 1-methylpropyl group, a 2-methylpropyl group, a cyclobutyl group, a cyclopropylmethyl group, an n-pentyl group, a 1-methylbutyl group, a 2-methylbutyl group, a 3-methylbutyl group, a cyclopentyl group, a cyclobutylmethyl group, an n-hexyl group, a 4-methylpentyl group, a 2-ethylbutyl group, a 1-ethyl-1-methylpropyl group, a cyclohexyl group, an n-heptyl group, a 1-methylhexyl group, a cyclohexylmethyl group, a 4-methylcyclohexyl group, a cycloheptyl group, an n-octyl group, a 2-ethylhexyl group, a methoxy group, an ethoxy group, an n-propoxy group, an isopropoxy group, an n-butoxy group, a t-butoxy group, a 1-methylpropoxy group, a 2-methylpropoxy group, a cyclopropylmethoxy group, a cyclobutoxy group, an n-pentyloxy group, a 1-methylbutoxy group, a 2-methylbutoxy group, a 3-methylbutoxy group, a 1-ethylpropoxy group, a 1,1-dimethylpropoxy group, a 1,2-dimethylpropoxy group, a 2,2-dimethylpropoxy group, a cyclopentyloxy group, a 1-methylcyclopropylmethoxy group, a 2-methylcyclopropylmethoxy group, an n-hexyloxy group, a 1-methylpentyloxy group, a 2-methylpentyloxy group, a 3-methylpentyloxy group, a 4-methylpentyloxy group, a 1-ethylbutoxy group, a 2-ethylbutoxy group, a 1,1-dimethylbutoxy group, a 3,3-dimethylbutoxy group, a 1,2-dimethylbutoxy group, a 1,3-dimethylbutoxy group, a 1,1,2-trimethylpropoxy group, a 1,2,2-trimethylpropoxy group, a 1-methyl-1-ethylpropoxy group, a 2-methyl-1-ethylpropoxy group, a cyclohexyloxy group, a cyclopentylmethoxy group, a 1-methylcyclopentyloxy group, a 2-methylcyclopentyloxy group, a 3-methylcyclopentyloxy group, an n-heptyloxy group, a 1-methylhexyloxy group, a 1-ethylpentyloxy group, a 5-ethylpentyloxy group, a 1,1-dimethylpentyloxy group, a 1,4-dimethylpentyloxy group, a 1-(1-methylethyl)butoxy group, a 1,3,3-trimethylbutoxy group, a 1-ethyl-2,2-dimethylpropoxy group, a 1-ethyl-1,2-dimethylpropoxy group, a 1,1-diethylpropoxy group, a diisopropylmethoxy group, a cycloheptyloxy group, a cyclohexylmethoxy group, a 1-cyclopentylethoxy group, a 1-methylcyclohexyloxy group, a 2-methylcyclohexyloxy group, a 3-methylcyclohexyloxy group, a 4-methylcyclohexyloxy group, an n-octyloxy group, a 1-methylheptyloxy group, a 2-ethylhexyloxy group, a 1,5-dimethylhexyloxy group, a 2-propylpentyloxy group, a 2-methyl-1-ethylpentyloxy group, a 2,4,4-trimethylpentyloxy group, a cyclooctyloxy group, a 1-cyclohexylethoxy group, a 2-cyclohexylethoxy group, a 2-ethylcyclohexyloxy group, a 4-ethylcyclohexyloxy group, a 2,3-dimethylcyclohexyloxy group, a 2,6-dimethylcyclohexyloxy group, a 3,5-dimethylcyclohexyloxy group, and a 3-cyclopentylpropoxy group.

Furthermore, specific examples of X¹, X² and X³ of the formula (2) include a methyl group, an ethyl group, an n-propyl group, an isopropyl group, an n-butyl group, a 1-methylpropyl group, a 2-methylpropyl group, a t-butyl group, an n-pentyl group, a 1-methylbutyl group, a 2-methylbutyl group, a 3-methylbutyl group, a 1,1-dimethylpropyl group, a 1,2-dimethylpropyl group, a 2,2-dimethylpropyl group, a 3,3-dimethylpropyl group, a 1-ethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 1,1,2-trimethylpropyl group, a 1,2,2-trimethylpropyl group, a 1,1,2,2-tetramethylethyl group, a 1-ethylbutyl group, and a 2-ethylbutyl group. Moreover, when easiness of availability of a starting raw material and a degree of polymerization or solubility in an organic solvent of the substituted polyacetylene are taken into consideration, it is preferable that X¹, X² and X³ of the formula (2) each independently represents a linear or branched alkyl group having from 1 to 4 carbon atoms; and specific examples thereof include a methyl group, an ethyl group, an n-propyl group, an isopropyl group, an n-butyl group, a 1-methylpropyl group, a 2-methylpropyl group, and a t-butyl group. It is more preferable that the group represented by the formula (2) is a trimethylsilyl group. The substituted polyacetylene containing such a substituent is fabricated into a membrane by a known method, whereby a substituted polyacetylene membrane can be obtained.

As the known membrane fabrication method, besides membrane fabrication methods such as a solvent casting method, a spin coating method, a transfer method, and a printing method, a heat treatment or a mechanical treatment such as rolling and stretching may be combined, if desired. The membrane fabrication method is not particularly limited so far as a membrane can be molded.

For the sulfonation method, a sulfonating agent such as concentrated sulfuric acid, a mixed solution of concentrated sulfuric acid and a solvent, fuming sulfuric acid, sulfur trioxide-dioxane, sulfur trioxide-pyridine, chlorosulfonic acid, and sulfurous acid can be used. In the case where the sulfonation is carried out in a liquid phase, a solvent or a surfactant can be used, if desired. The solvent or surfactant is not particularly limited so far as it does not adversely affect properties of the membrane or control of the sulfonation. For example, as the solvent, water, an alcohol having from 1 to 8 carbon atoms, ethyl acetate, butyl acetate, chloroform, dichloromethane, 1,2-dichloroethane, formic acid, acetic acid, butyric acid, acetic anhydride, chloroacetic acid, trifluoroacetic acid, trifluoroacetic anhydride, nitrobenzene, and the like can be used singly or in admixture of two or more kinds thereof. As the surfactant, ionic surfactants such as salts of a quaternary ammonium ion (for example, tetramethyl ammonium, tetraethyl ammonium, tetrapropyl ammonium, and tetrabutyl ammonium) and a chloride ion, a bromide ion, an iodide ion, a hydrogensulfide ion or the like, and sodium salts or ammonium salts of nonanylbenzenesulfonic acid, lauryl-sulfuric acid, benzoic acid or the like; and nonionic surfactants (for example, propylene glycol and polyoxyethylene glycol monolauryl ether) can be used singly or in admixture of two or more kinds thereof. In the case where the reaction is carried out in a gas phase, for example, though the membrane may be exposed directly to a sulfurous acid group, the reaction can be carried out while controlling a sulfonation atmosphere or by using, as a mobile phase, a nitrogen gas, air or vapors of the above-enumerated solvents singly or in admixture of two or more kinds thereof. The amount of the sulfonating reagent, the amount of the solvent or surfactant, the amount of the gas, the time and temperature required for the sulfonation treatment, and soon may be determined on the basis of the amount of sulfonation depending upon electrochemical characteristics necessary for the targeted electrochemical device. Taking into consideration the production efficiency, the treatment time may be determined such that it falls within the range of from several minutes to several hours.

Of the sulfonating agents, concentrated sulfuric acid or a mixed solution of concentrated sulfuric acid and a solvent is preferable because not only it is cheap from the industrial viewpoint and relatively easy for handling, but also it is able to be reused. The solvent which is mixed with concentrated sulfuric acid is not particularly limited so far as it is a solvent which does not react with concentrated sulfuric acid, and the above-enumerated solvents can be used. With respect to the concentration of concentrated sulfuric acid and the solvent, the amount of concentrated sulfuric acid is from 100 to 20% by weight, preferably from 100 to 50% by weight, and more preferably from 100 to 80% by weight.

In the case where the substituted polyacetylene membrane is dipped in the foregoing sulfonating agent, the membrane may be previously dipped and swollen in the solvent. The solvent capable of swelling the substituted polyacetylene membrane therein is not particularly limited so far as the membrane is not dissolved therein, and examples thereof include ethyl acetate and diethyl ether. Furthermore, the temperature at which the substituted polyacetylene membrane is dipped is not particularly limited so far as it is not higher than a boiling point of the used solvent and is preferably from −30 to 200° C., and more preferably from 0 to 100° C.

### EXAMPLES

The invention is hereunder described in more detail with reference to the following Examples. Incidentally, with respect to a preparation method of a membrane used in each of the Examples and Comparative Examples, a monomer synthesis, a polymer synthesis, a membrane fabrication method and a desilylation method are described in this order. Furthermore, as comparative examples, results obtained by adding a sulfonating agent in a polymer solution and sulfonating the polymer and results obtained by sulfonating a substituted polyacetylene membrane not containing the subject silyl group are described. Incidentally, a ¹H-NMR spectrum, an FT-IR spectrum, a molecular weight, a membrane thickness, an ion exchange capacity, a water uptake, a swelling ratio, an ionic conductivity, and distribution of a sulfonic group were determined in the following manners.

1. ¹H-NMR Spectrum:

A ¹H-NMR spectrum was measured by using a nuclear magnetic resonance device (a trade name: AVNCE DRX 400, manufactured by Burker BioSpin Corporation).

2. FT-IR Spectrum:

An FT-IR spectrum was measured by a KBr disk method by using an FT-IR analyzer (a trade name: PARAGON FT-IR, manufactured by PerkinElmer Inc.).

3. Molecular Weight:

With respect to a molecular weight, the obtained polymer was dissolved in tetrahydrofuran (THF), and a number average molecular weight and a weight average molecular weight were measured by using a gel permeation chromatography (GPC) (a trade name: HLC-802A, manufactured by Tosoh Corporation). THF was used as an eluent, and polystyrene was used as a standard sample.

4. Membrane Thickness:

A prescribed amount of a membrane was vacuum dried at 110° C. for 16 hours; and a periphery and five points in a central part of the membrane were measured for thickness by using a membrane thickness meter (a trade name: QUICK MICRO, manufactured by Mitutoyo Corporation); and an average value of the measured values was calculated.

5. Ion Exchange Capacity:

A prescribed amount of a membrane was dried in vacuo at 110° C. for 16 hours, and its weight was measured. Thereafter, the membrane was dipped in 50 mL of a 0.1 mole/L sodium chloride aqueous solution and gently stirred for 16 hours. Thereafter, the membrane was taken out and titrated with a 1/50 N sodium hydroxide aqueous solution. For the titration, an automatic titrator (a trade name: AUT-501, manufactured by DKK-Toa Corporation) was used, a point of inflection of a titration curve was defined as a point of neutralization (end point), and an ion exchange capacity was calculated according to the following expression (1).

Expression (1)
[Ion exchange capacity (meq/g)]={0.02×(Factor)×[Consumed amount of 1/50 N sodium hydroxide aqueous solution (mL)]}/[Weight of membrane (g)]
6. Water Uptake:

A prescribed amount of a membrane was boiled with a 1.0 mole/L sulfuric acid aqueous solution for one hour and further boiled with pure water for one hour, and its weight was measured. Thereafter, the membrane was dried in vacuo at 110° C. for 16 hours, its weight was measured, and a water uptake was calculated according to the following expression (2).

Expression (2)
[Water uptake (%)]={[Weight of hydrated membrane (g)]−[Weight at drying (g)]}/[Weight at drying (g)]×100
7. Swelling Ratio:

A prescribed amount of a membrane was boiled with a 1.0 mole/L sulfuric acid aqueous solution for one hour and further boiled with pure water for one hour, and its size (length×width×thickness) was measured. Thereafter, the membrane was dried in vacuo at 110° C. for 16 hours, its size was measured, and a swelling ratio was calculated according to the following expression (3).

Expression (3)
[Swelling ratio(%)]=[Volume at swelling (mm³)]/[Volume at drying (mm³)]×100
8. Ionic Conductivity:

A membrane was cut out into a size of 2 cm×5 cm and subjected to a boiling treatment with a 1 mole/L sulfuric acid aqueous solution for one hour. Subsequently, after boiling with distilled water for one hour, the membrane was brought into intimate contact with gold electrodes having a length of 4 cm as disposed in parallel at an interval of 0.5 cm and then subjected to impedance measurement at a frequency in the range of from 0.5 Hz to 10 MHz by using an impedance analyzer (a trade name: SOLARTRON 1260, manufactured by TOYO Corporation) within a thermo-hydrostat at 90° C. while controlling a relative humidity at 90%. An impedance was determined from the resulting Nyquist plot, and an ionic conductivity was calculated according to the following expression (4).

Expression (4)
[Ionic conductivity (S/cm)]=[0.5 (cm)]/{[Impedance (Ω)]×[4 (cm)]×[Membrane thickness (cm)]}
9. Measurement of Distribution of Sulfonic Group in a Membrane Thickness Direction:

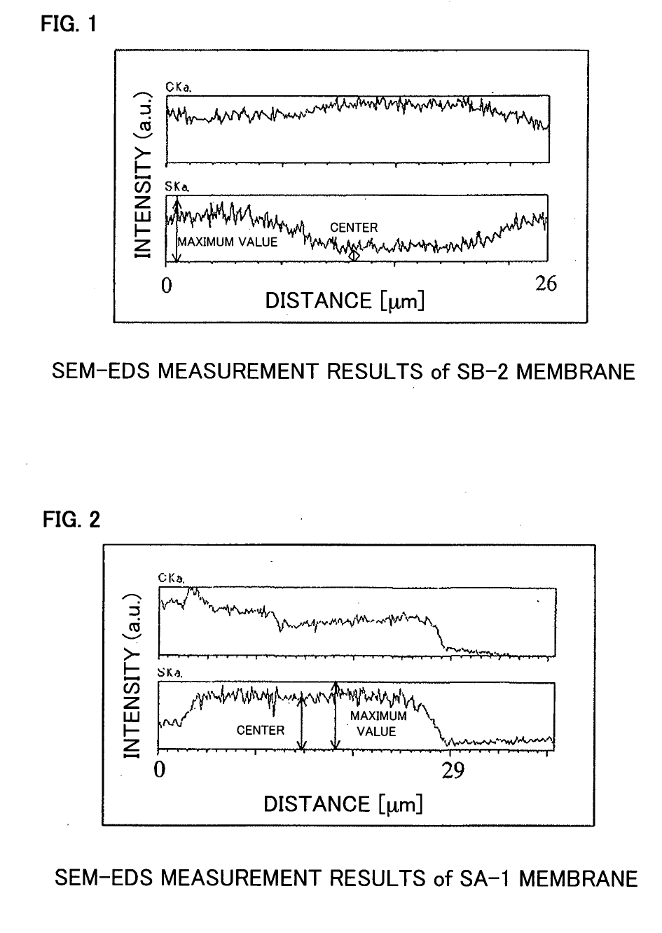

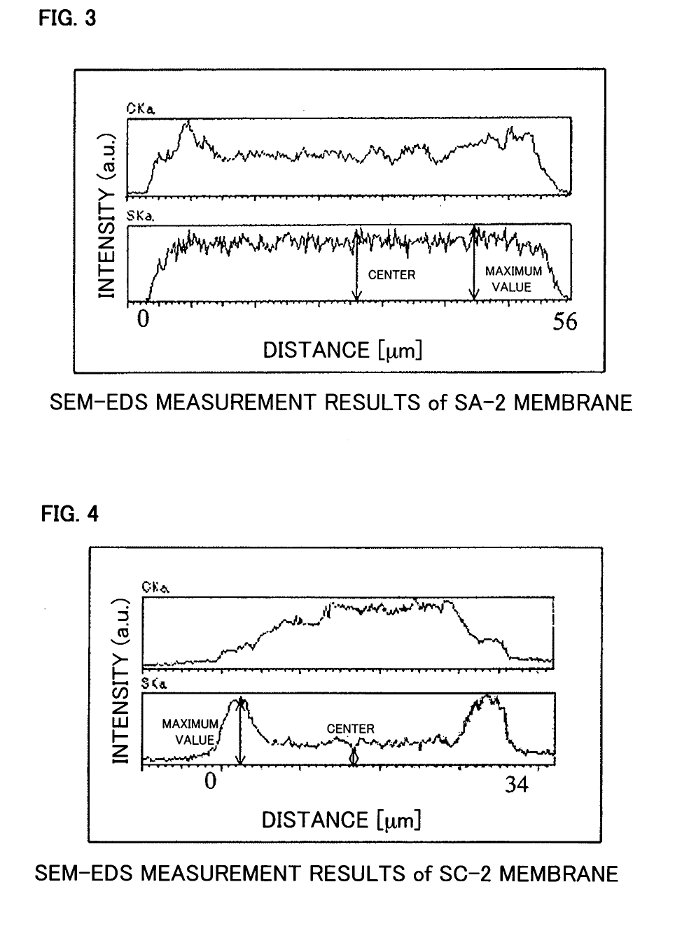

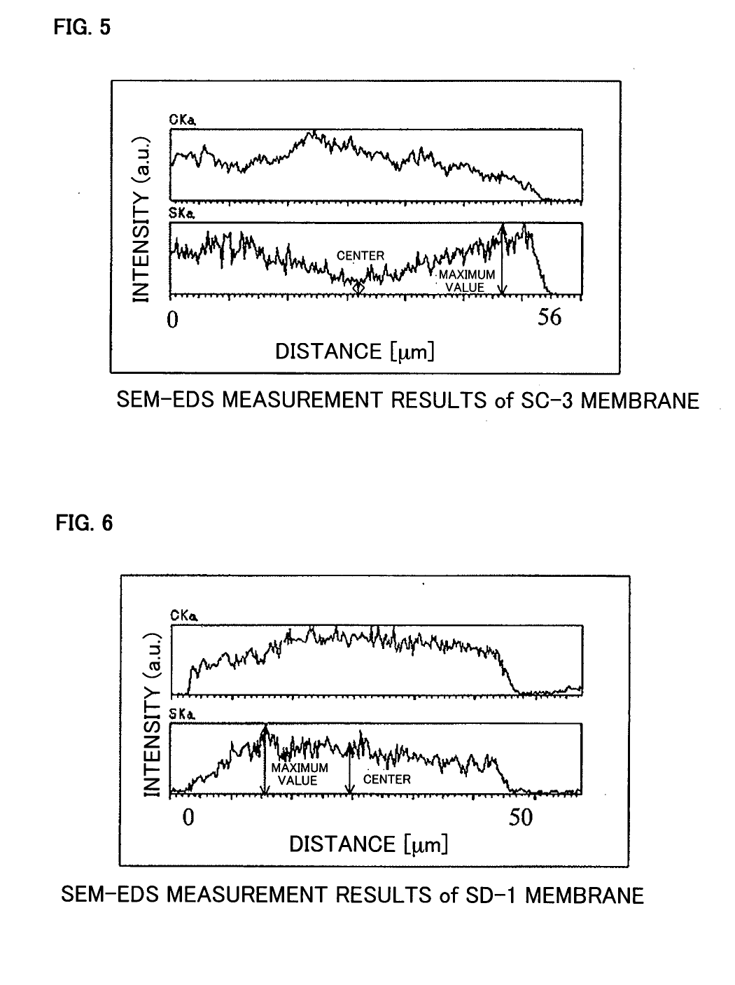

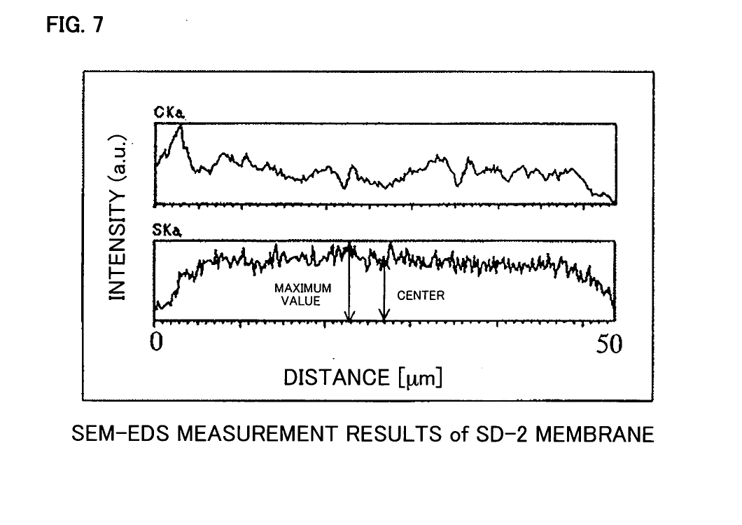

A membrane was cut out into a small piece; after fixing in a sample holder, the small piece was subjected to Pt—Pd vapor deposition; and the distribution of carbon and sulfur in a membrane thickness direction of the sample was analyzed by using SEM-EDS (scanning electron microscope-energy dispersive X-ray spectrometer) (a trade name: JSM-5800LV, manufactured by JEOL Ltd.). In the graphs as shown in FIGS. 1 to 7, CKa and SKa represent a characteristic X-ray intensity of carbon and a characteristic X-ray intensity of sulfur, respectively. CKa and SKa are corresponding to relative values of the existent position and existent amount of a substituted polyacetylene membrane and a sulfonic group, respectively. As an index to exhibit that the sulfonic group is uniformly introduced, an intensity ratio (α) of SKa of a central part of the membrane to a maximum value of SKa was employed. 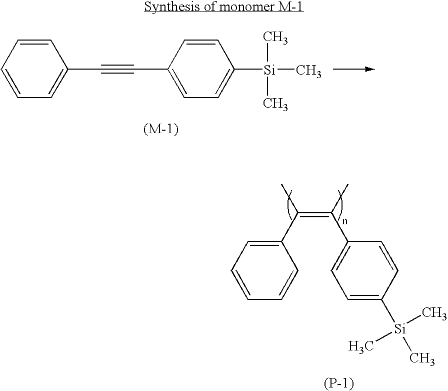
(Synthesis of Monomer M-1)

In a 200-mL three-necked flask, 17 mg (0.024 mmoles) of bis(triphenylphosphine)palladium(II) dichloride, 23 mg (0.12 mmoles) of copper iodide and 32 mg (0.12 mmoles) of triphenylphosphine were weighed under an argon atmosphere. Thereafter, 70 mL (0.50 mmoles) of triethylamine which had been previously dehydrated with potassium hydride was added. Furthermore, 1.6 mL (8.0 mmoles) of 1-bromo-4-(trimethylsilyl)benzene and 0.90 mL (8.0 mmoles) of phenylacetylene were added, and the mixture was stirred at 90° C. for 16 hours.

Thereafter, the triethylamine was distilled off, and diethyl ether was added to the residue, followed by filtration. A filtrate was concentrated and purified by silica gel column chromatography (solvent: hexane). Thereafter, the purified product was further purified by alumina column chromatography (solvent: hexane). There was thus obtained 1.2 g (yield: 61%) of a transparent viscous liquid. The product was confirmed to be M-1 by ¹H-NMR and IR measurement.

¹H-NMR, δ (ppm, CDCl₃, 400 MHz): 0.28 (9H, s, CH₃×3), 7.33 (2H, m, Ph), 7.35 (1H, m, Ph), 7.50 (4H, s, Ph), 7.53 (2H, m, Ph).

IR, ν (KBr disk, cm⁻¹): 3065 (w), 2956 (m, C—H), 2219 (vw, C≡C), 1601 (m, arC-C), 1249 (s), 1101 (w), 855 (s, Si—C), 839 (s), 820 (s), 755 (m), 690 (s), 627 (w), 633 (m).

(Synthesis of Polymer P-1)

In a globe box, 55 mg (0.15 mmoles) of tantalum(V) pentachloride and 0.10 mL (0.31 mmoles) of tetrabutyltin(IV) were added in a 50-mL eggplant type flask. Furthermore, 4.0 mL of dehydrated toluene was added, the mixture was stirred at 80° C. for 20 minutes, and a catalyst solution was ripened. Also, in a 50-mL eggplant type flask, 1.0 g (4.0 mmoles) of M-1 was weighed under an argon atmosphere, to which was then added 4.0 mL of dehydrated toluene. Thereafter, the monomer solution was added to the catalyst solution by a cannula, and the mixture was stirred at 80° C. for 2 hours. The reaction mixture was diluted and deposited in methanol, thereby obtaining 0.70 g (yield: 73%) of a yellow fiber. This product was confirmed to be P-1 by IR measurement. Also, an average molecular weight was measured by GPC measurement.

IR, ν (KBr disk, cm⁻¹): 3055 (w, arC-H), 3017 (w), 2957 (s, C—H), 1646 (vw, >C═C<), 1597 (w, arC-C), 1494 (w), 1248 (s), 1118 (m), 855 (s, Si—C), 835 (s), 814 (s), 755 (s), 689 (s), 630 (w), 554 (s).

GPC measurement results: Number average molecular weight=6.0×10⁵; Weight average molecular weight=6.1×10⁵.

(Preparation of Membrane A)

In a 300-mL eggplant type flask, 0.2 g of P-1 was weighed, 50 mL of toluene was added, and the mixture was dissolved at 100° C. for 16 hours. Thereafter, a TEFLON® frame having a width of 1 cm was installed in a glass plate of 10 cm×10 cm disposed horizontally within a thermostat, and the toluene solution of P-1 was cast thereon. The glass plate was allowed to stand at 60° C. for 3 days, thereby obtaining a strong yellow membrane A-1 having a thickness of 29 μm. Furthermore, a membrane A-2 having a different thickness (thickness: 56 μm) was synthesized in the same procedures, except for changing the amount of P-1.
(Preparation of Membrane B) (Desilylation Treatment of Membrane A)

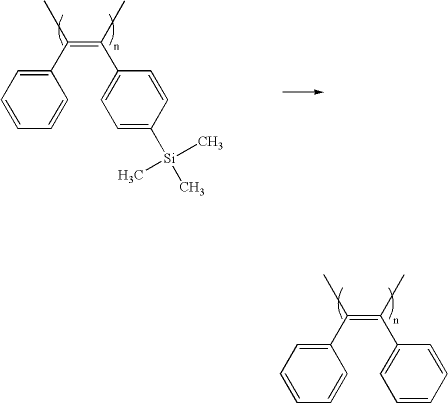

(Membrane B)

In a 10-mL eggplant type flask, 50 mL of a hexane/trifluoroacetic acid (1/1) solution was added, and the membrane A-1 was impregnated therewith and stirred at room temperature for 24 hours. Thereafter, the membrane was impregnated with 50 mL of a hexane solution and stirred for 16 hours. Thereafter, the membrane was dried at 110° C. for 16 hours, thereby obtaining a strong yellow membrane B-1 having a thickness of 28 μm. It was confirmed by IR measurement that the membrane had been desilylated. The membrane A-2 was desilylated in the same manner, thereby obtaining a membrane B-2.

IR, ν (cm⁻¹, KBr disk,): 3085 (w), 3054 (s, arC-H), 3019 (m), 2959 (vw, C—H), 2923 (vw, C—H), 1661 (vw, >C═C<), 1599 (w, arC-C), 1576 (w), 1494 (s, arc-C), 1442 (s, arC-C), 1250 (w), 1156 (w), 1076 (w), 1030 (w), 902 (m), 830 (w), 769 (s), 691 (s), 553 (s). 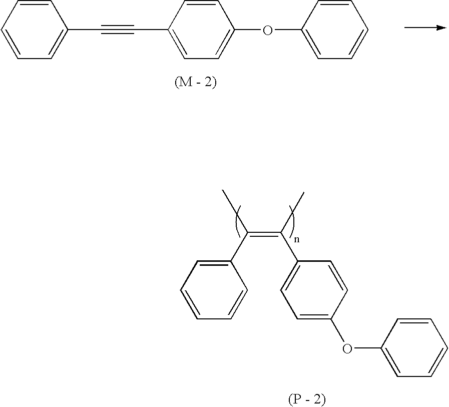
Synthesis of Monomer M-2
(Synthesis of Monomer M-2)

In a 200-mL three-necked flask, 62 mg (0.089 mmoles) of bis(triphenylphosphine)palladium(II) dichloride, 85 mg (0.44 mmoles) of copper iodide and 0.12 g (0.44 mmoles) of triphenylphosphine were weighed under an argon atmosphere. Thereafter, 30 mL of triethylamine which had been previously dehydrated with potassium hydride was added. Furthermore, 3.3 mL (30 mmoles) of phenylacetylene and 5.2 mL (30 mmoles) of 4-bromodihenyl ether were added, and the mixture was stirred at 90° C. for 4 hours. The triethylamine was distilled off, and diethyl ether was then added for extraction, followed by filtration. A filtrate washed with water and further evaporated, and the residue was purified by silica gel column chromatography (solvent: hexane), thereby obtaining 3.1 g (yield: 39%) of a white solid. The product was confirmed to be M-2 by ¹H-NMR and IR measurement.

¹H-NMR, δ (ppm, CDCl₃, 400 MHz): 6.97 (2H, d, J=8.8 Hz, Ph), 7.20 (2H, d, J=8.8 Hz, Ph), 7.15 (1H, t, J=8 Hz, Ph), 7.32 to 7.39 (5H, m, Ph), 7.50 to 7.54 (4H, m, Ph).

IR, ν (cm⁻¹, KBr disk,): 3050 (m, arC-H), 2360 (w, C≡C), 1591 (s, arC-C), 1490 (s, arC-C), 1286(s), 1258 (s, arC-O-arC), 1105 (s), 1071 (s), 838 (s), 751 (s), 691 (s).

(Synthesis of Polymer P-2)

In a globe box, 0.26 g (0.69 mmoles) of tantalum pentachloride and 0.45 mL (1.4 mmoles) of tetrabutylthin(IV) were added in a 100-mL two-necked flask under an argon atmosphere. Furthermore, 15 mL of dehydrated toluene was added, the mixture was stirred at 80° C. for 20 minutes, and a catalyst solution was ripened. Also, in a 100-mL eggplant type flask, 1.0 g (2.9 mmoles) of M-2 was weighed under an argon atmosphere, to which was then added 15 mL of dehydrated toluene. Thereafter, the monomer solution was added to the catalyst solution by a cannula, and the mixture was stirred for 24 hours. Thereafter, the reaction mixture was deposited in methanol, thereby obtaining 0.62 g (yield: 62%) of a yellowish brown fiber. This product was confirmed to be P-2 by IR measurement. Also, an average molecular weight was measured by GPC measurement.

IR, ν (cm⁻¹, KBr, disk): 3052 (w, arC-H), 1588 (m, arC-C), 1489 (s, arC-C), 1237 (s, arC-O-arC), 890 (s), 750 (m).

GPC measurement results: Number average molecular weight=1.4×10⁶; Weight average molecular weight=1.5×10⁶.

(Preparation of Membrane C)

In a 500-mL eggplant type flask, 0.20 g of P-2 was weighed, 50 mL of toluene was added, and the mixture was stirred at 90° C. for 16 hours. Thereafter, a TEFLON® frame having a width of 1 cm was installed in a glass plate of 10 cm×10 cm disposed horizontally within a thermostat, and the toluene solution of P-2 was cast thereon. Thereafter, the glass plate was allowed to stand at 50° C. for 6 hours, thereby obtaining a yellow membrane C-1 having a thickness of 29 μm. Furthermore, a membrane C-2 (thickness: 35 μm) and a membrane C-3 (thickness: 55 μm) each having a different thickness were synthesized in the same procedures, except for changing the amount of P-2. 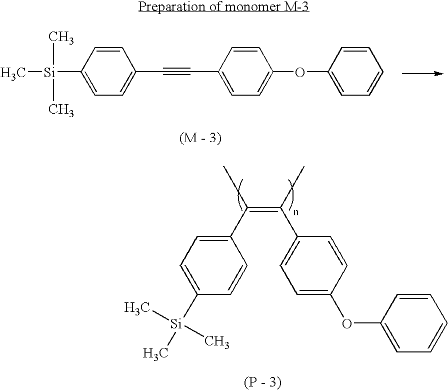
(Synthesis of Monomer M-3)

In a 200-mL three-necked flask, 25 mg (0.035 mmoles) of bis(triphenylphosphine)palladium(II) dichloride, 6.7 mg (0.035 mmoles) of copper iodide, 0.047 mg (0.18 mmoles) of tri-phenylphosphine and 2.3 g (12 mmoles) of 4-ethynyl diphenyl ether were weighed under an argon atmosphere. Thereafter, 5.9 mL of triethylamine which had been previously dehydrated with potassium hydride was added. Furthermore, 2.5 mL (12 mmoles) of 1-bromo-4-(trimethylsilyl)benzene was added, and the mixture was stirred at 90° C. for 4 hours. The triethylamine was distilled off, and diethyl ether was then added for extraction, followed by filtration. A filtrate washed with water and further evaporated, and the residue was purified by silica gel column chromatography (solvent: hexane), thereby obtaining 3.0 g (yield: 75%) of a white solid. The product was confirmed to be M-3 by ¹H-NMR and IR measurement.

¹H-NMR, δ (ppm, CDCl₃, 400 MHz): 0.28 (9H, s, CH₃×3), 6.97 (2H, m, Ph), 7.05 (2H, m, Ph), 7.15 (1H, m, Ph), 7.37 (2H, m, Ph), 7.50 (6H, m, Ph).

IR, ν (cm⁻¹, KBr disk,): 3067 (m, arC-H), 2954 (w, C—H st), 2213 (w, C≡C), 1587 (m, arC-C), 1508 (m), 1487 (s, arC-C), 1244 (s, arC-O-arC), 1163 (m), 1099 (s), 838 (s, Si—C), 819 (s), 751 (s), 690 (m), 518 (m).

(Synthesis of Polymer P-3)

In a globe box, 0.45 g (1.17 mmoles) of tantalum pentachloride and 0.81 mL (2.3 mmoles) of tetrabutylthin(IV) were added in a 100-mL two-necked flask under an argon atmosphere. Furthermore, 38 mL of dehydrated toluene was added, the mixture was stirred at 80° C. for 20 minutes, and a catalyst solution was ripened. Also, in a 100-mL eggplant type flask, 2.0 g (5.9 mmoles) of M-3 was weighed under an argon atmosphere, to which was then added 20 mL of dehydrated toluene. Thereafter, the monomer solution was added to the catalyst solution by a cannula, and the mixture was stirred for 24 hours. Thereafter, the reaction mixture was deposited in methanol, thereby obtaining 1.0 g (yield: 50%) of a yellowish brown fiber. This product was confirmed to be P-3 by IR measurement. Also, an average molecular weight was measured by GPC measurement.

IR, ν (cm⁻¹, KBr, disk): 3064 (w, arC-H), 1590 (s, arC-C), 1488 (s, arC-C), 1241 (s, arC-O-arC), 836 (s, Si—C), 750 (s), 690 (s).

GPC measurement results: Number average molecular weight=3.8×10⁶; Weight average molecular weight=5.8×10⁶.

(Preparation of Membrane D)

In a 500-mL eggplant type flask, 0.20 g of P-3 was weighed, 60 mL of tetrahydrofuran was added, and the mixture was stirred at 70° C. for 16 hours. Thereafter, a TEFLON® frame having a width of 1 cm was installed in a glass plate of 10 cm×10 cm disposed horizontally within a thermostat, and the tetrahydrofuran solution of P-3 was cast thereon. Thereafter, the glass plate was allowed to stand at 50° C. for 6 hours, thereby obtaining a yellow membrane D-1 having a thickness of 50 μm. Furthermore, a membrane D-2 having a different thickness (thickness: 40 μm) was synthesized in the same procedures, except for changing the amount of P-3.

### Comparative Example 1

### Sulfonation of P-1 by Adding a Sulfonating Agent in a P-1 Solution

In a 50-mL eggplant type flask, 20 mg of P-1 was weighed under an argon atmosphere, 7.0 mL of dichloromethane (dehydrated) was added, and the mixture was stirred at room temperature for 16 hours, thereby preparing a dichloromethane solution of P-1. 0.5 mL of a mixture of chlorosulfonic acid and dichloromethane (1/99 by volume) was added dropwise to this polymer solution. As a result, a fibrous precipitate was formed. After stirring for 2 hours, the reaction solution was added in diethyl ether, and the precipitate was separated by filtration and dried in vacuo at 60° C. for 16 hours. Thereafter, the product was subjected to IR measurement. As a result, elimination of a trimethylsilyl group and introduction of a sulfonic group were confirmed. On the other hand, the precipitate was insoluble in N,N-dimethyl sulfoxide, N,N-dimethylacetamide, m-cresol, methanol, acetone, ethyl acetate, and water.

IR, ν (cm⁻¹, KBr, disk): 3443 (s), 1637 (m, arC-C), 1216 (m), 1178 (m), 1128 (m, SO₃H), 1036 (m, SO₃H), 1009 (s), 759 (w), 689 (m), 578 (w).

### Comparative Example 2

### Sulfonation of P-2 by Adding a Sulfonating Agent in a P-2 Solution

In a 50-mL eggplant type flask, 20 mg of P-2 was weighed under an argon atmosphere, 3.5 mL of dichloromethane (dehydrated) was added, and the mixture was stirred at room temperature for 16 hours, thereby preparing a dichloromethane solution of P-2. 0.25 mL of a mixture of chlorosulfonic acid and dichloromethane (1/99 by volume) was added dropwise to this polymer solution. As a result, a fibrous precipitate was formed. After stirring for 2 hours, the reaction solution was added in diethyl ether, and the precipitate was separated by filtration and dried in vacuo at 60° C. for 16 hours. Thereafter, the product was subjected to IR measurement. As a result, elimination of a trimethylsilyl group and introduction of a sulfonic group were confirmed. On the other hand, the precipitate was insoluble in N,N-dimethyl sulfoxide, N,N-dimethylacetamide, m-cresol, methanol, acetone, ethyl acetate, and water.

IR, ν (cm⁻¹, KBr, disk): 3444 (s), 1637 (m, arC-C), 1490 (m, arC-C), 1241 (m, arC-O-arC)), 1169 (m), 1125 (w, SO₃H), 1033 (m, SO₃H), 1007 (s), 694 (m), 607 (w), 552 (w).

### Comparative Example 3

### Sulfonation of Membrane B-1 (Synthesis of Membrane SB-1)

In a 50-mL eggplant type flask, 10 mL of concentrated sulfuric acid (97%) was weighed, and 1.8 mg of the membrane B-1 was dipped therein and gently stirred at room temperature for 3 hours. After taking out the membrane, it washed with water and further boiled with pure water for one hour. Thereafter, the membrane was dried in vacuo at 110° C. for 16 hours, thereby obtaining a membrane SB-1. This membrane was subjected to IR measurement. However, introduction of a sulfonic group was not confirmed.

IR, ν (cm⁻¹, KBr disk): 3055 (s, arC-H), 1599 (w, arC-C), 1491 (s, arC-C), 1440 (m), 1246 (m), 1162 (w), 903 (m), 832 (w), 754 (m), 687 (s), 548 (s).

The obtained membrane had a thickness of 28 μm, and its ion exchange capacity was not more than a detection limit.

### Comparative Example 4

### Sulfonation of Membrane B-2 (Synthesis of Membrane SB-2)

In a 100-mL eggplant type flask, 50 mL of concentrated sulfuric acid (97%) was weighed, and 41 mg of the membrane B-2 was dipped therein and gently stirred at room temperature for 16 hours. After taking out the membrane, it washed with water and further boiled with pure water for one hour. Thereafter, the membrane was dried in vacuo at 110° C. for 16 hours, thereby obtaining a green membrane SB-2. This membrane was subjected to IR measurement. As a result, it was confirmed that a sulfonation reaction proceeded.

IR, ν (cm⁻¹, KBr disk): 3056 (w, arC-H), 1632 (m, arC-C), 1490 (s, arC-C), 1440 (s), 1254 (s), 1168 (m), 1128 (w, SO₃H), 1032 (w, SO₃H), 1003 (w), 906 (w), 829 (w), 755 (s), 690 (s), 567 (m).

The obtained membrane had a thickness of 26 μm, an ion exchange capacity of 1.4 meq/g, a water uptake of 21%, a swelling ratio of 156%, and an ionic conductivity of 5.6×10⁻³ S/cm (at 90° C. and RH 90%).

### Example 1

### Sulfonation of Membrane A-1 (Synthesis of Membrane SA-1)

In a 100-mL eggplant type flask, 50 mL of concentrated sulfuric acid (97%) was weighed, and 69 mg of the membrane A-1 was dipped therein and gently stirred at room temperature for 3 hours. After taking out the membrane, it washed with water and further boiled with pure water for one hour. Thereafter, the membrane was dried in vacuo at 110° C. for 16 hours, thereby obtaining a green membrane SA-1. This membrane was subjected to IR measurement. As a result, it was confirmed that a desilylation reaction and a sulfonation reaction proceeded.

IR, ν (cm⁻¹, KBr disk): 3056 (w, arC-H), 1642 (m, arC-C), 1492 (s, arC-C), 1442 (w), 1218 (s), 1154 (s), 1128 (w, SO₃H), 1033 (w, SO₃H), 1005 (w), 907 (w), 825 (w), 755 (s), 691 (s), 572 (m).

The obtained membrane had a thickness of 29 μm, an ion exchange capacity of 2.3 meq/g, a water uptake of 80%, a swelling ratio of 282%, and an ionic conductivity of 3.7×10⁻¹ S/cm (at 90° C. and RH 90%).

### Example 2

### Sulfonation of Membrane A-2 (Synthesis of Membrane SA-2)

In a 100-mL eggplant type flask, 50 mL of a mixed solution of concentrated sulfuric acid (97%) and ethyl acetate (concentrated sulfuric acid/ethyl acetate=80/20) was weighed, and 52 mg of the membrane A-2 was dipped therein and gently stirred at room temperature for 16 hours. After taking out the membrane, it washed with water and further boiled with pure water for one hour. Thereafter, the membrane was dried in vacuo at 110° C. for 16 hours, thereby obtaining a green membrane SA-2. This membrane was subjected to IR measurement. As a result, it was confirmed that a desilylation reaction and a sulfonation reaction proceeded.

IR, ν (cm⁻¹, KBr disk): 3056 (w, arC-H), 1634 (m, arC-C), 1490 (s, arC-C), 1441 (w), 1215 (s), 1159 (s), 1128 (s, SO₃H), 1032 (w, SO₃H), 1003 (w), 910 (w), 827 (w), 756 (s), 693 (s), 572 (m).

The obtained membrane had a thickness of 56 μm, an ion exchange capacity of 2.1 meq/g, a water uptake of 78%, a swelling ratio of 375%, and an ionic conductivity of 2.4×10⁻¹ S/cm (at 90° C. and RH 90%).

### Comparative Example 5

### Sulfonation of Membrane C-1 (Synthesis of Membrane SC-1)

In a 100-mL eggplant type flask, 30 mL of concentrated sulfuric acid (97%) was weighed, and 56 mg of the membrane C-1 was dipped therein and gently stirred at room temperature for 16 minutes. After taking out the membrane, it washed with water and further boiled with pure water for one hour. Thereafter, the membrane was dried in vacuo at 110° C. for 16 hours, thereby obtaining a green membrane SC-1. This membrane was subjected to IR measurement. However, introduction of a sulfonic group was not confirmed.

IR, ν (cm⁻¹, KBr disk): 3053 (m, arC-H), 1588 (m, arC-C), 1487 (s, arC-C), 1238 (s, arC-O-arC), 1164 (s), 869 (w), 750 (s), 689 (s).

The obtained membrane had a thickness of 28 μm, and its ion exchange capacity was not more than a detection limit.

### Comparative Example 6

### Sulfonation of Membrane C-2 (Synthesis of Membrane SC-2)

In a 100-mL eggplant type flask, 50 mL of concentrated sulfuric acid (97%) was weighed, and 69 mg of the membrane C-2 was dipped therein and gently stirred at room temperature for one hour. After taking out the membrane, it washed with water and further boiled with pure water for one hour. Thereafter, the membrane was dried in vacuo at 110° C. for 16 hours, thereby obtaining a green membrane SC-2. This membrane was subjected to IR measurement. As a result, it was confirmed that a sulfonation reaction proceeded.

IR, ν (cm⁻¹, KBr disk): 3056 (w, arC-H), 1588 (m, arC-C), 1489 (s, arC-C), 1240 (s, arC-O-arC), 1166 (s), 1123 (s, SO₃H), 1030 (s, SO₃H), 1003 (s), 831 (w), 748 (s), 690 (s).

The obtained membrane had a thickness of 34 μm, an ion exchange capacity of 1.1 meq/g, a water uptake of 15%, a swelling ratio of 106%, and an ionic conductivity of 1.0×10⁻¹ S/cm (at 90° C. and RH 90%).

### Comparative Example 7

### Sulfonation of Membrane C-3 (Synthesis of Membrane SC-3)

In a 100-mL eggplant type flask, 50 mL of a mixed solution of concentrated sulfuric acid (97%) and ethyl acetate (concentrated sulfuric acid/ethyl acetate=80/20) was weighed, and 65 mg of the membrane C-3 was dipped therein and gently stirred at room temperature for 3 hours. After taking out the membrane, it washed with water and further boiled with pure water for one hour. Thereafter, the membrane was dried in vacuo at 110° C. for 16 hours, thereby obtaining a green membrane SC-3. This membrane was subjected to IR measurement. As a result, it was confirmed that a sulfonation reaction proceeded.

IR, ν (cm⁻¹, KBr disk): 3056 (w, arC-H), 1588 (m, arC-C), 1489 (s, arC-C), 1239 (s, arC-O-arC), 1164 (s), 1123 (s, SO₃H), 1029 (s, SO₃H), 1004 (s), 832 (w), 751 (s), 691 (s).

The obtained membrane had a thickness of 56 μm, an ion exchange capacity of 1.0 meq/g, a water uptake of 22%, a swelling ratio of 127%, and an ionic conductivity of 3.8×10⁻² S/cm (at 90° C. and RH 90%).

### Example 3

### Sulfonation of Membrane D-1 (Synthesis of Membrane SD-1)

In a 100-mL eggplant type flask, 50 mL of concentrated sulfuric acid (97%) was weighed, and 49 mg of the membrane D-1 was dipped therein and gently stirred at room temperature for 16 minutes. After taking out the membrane, it washed with water and further boiled with pure water for one hour. Thereafter, the membrane was dried in vacuo at 110° C. for 16 hours, thereby obtaining a green membrane SD-1. This membrane was subjected to IR measurement. As a result, it was confirmed that a desilylation reaction and a sulfonation reaction proceeded.

IR, ν (cm⁻¹, KBr disk): 3056 (w, arC-H), 1588 (m, arC-C), 1489 (s, arC-C), 1238 (s, arC-O-arC), 1164 (s), 1122 (s, SO₃H), 1028 (s, SO₃H), 1002 (s), 830 (w), 753 (s), 691 (s).

The obtained membrane had a thickness of 50 μm, an ion exchange capacity of 1.9 meq/g, a water uptake of 65%, a swelling ratio of 151%, and an ionic conductivity of 8.0×10⁻² S/cm (at 90° C. and RH 90%).

### Example 4

### Sulfonation of Membrane D-2 (Synthesis of Membrane SD-2)

In a 100-mL eggplant type flask, 50 mL of a mixed solution of concentrated sulfuric acid (97%) and ethyl acetate (concentrated sulfuric acid/ethyl acetate=80/20) was weighed, and 30 mg of the membrane D-2 was dipped therein and gently stirred at room temperature for 3 hours. After taking out the membrane, it washed with water and further boiled with pure water for one hour. Thereafter, the membrane was dried in vacuo at 110° C. for 16 hours, thereby obtaining a green membrane SD-2. This membrane was subjected to IR measurement. As a result, it was confirmed that a desilylation reaction and a sulfonation reaction proceeded.

IR, ν (cm⁻¹, KBr disk): 3056 (w, arC-H), 1587 (m, arC-C), 1492 (s, arC-C), 1239 (s, arC-O-arC), 1163 (s), 1122 (s, SO₃H), 1028 (s, SO₃H), 1001 (s), 830 (w), 752 (s), 692 (s).

The obtained membrane had a thickness of 40 μm, an ion exchange capacity of 1.5 meq/g, a water uptake of 63%, a swelling ratio of 262%, and an ionic conductivity of 4.7×10⁻¹ S/cm (at 90° C. and RH 90%).

The SEM-EDS measurement results in a membrane thickness direction of the Comparative Examples and Examples are shown in FIGS. 1 to 7. Furthermore, a of each of the samples is shown in Table 1. It is shown that in the Examples, the intensity in the central part of the membrane is large as compared with that of the Comparative Examples and the sulfonic group is uniformly introduced.

TABLE 1
Characteristic X-ray intensity of sulfur in the
central part of membrane (relative value)

| | Sample | α (%) |
|---|---|---|
| Comparative Example 4 | SB-2 | 16.3 |
| Comparative Example 6 | SC-2 | 27.2 |
| Comparative Example 7 | SC-3 | 18.2 |
| Example 1 | SA-1 | 78.2 |
| Example 2 | SA-2 | 92.2 |
| Example 3 | SD-1 | 71.4 |
| Example 4 | SD-2 | 77.9 |

1. A process of producing a sulfonic group-containing substituted polyacetylene membrane, which comprises molding a substituted polyacetylene containing a repeating unit represented by the following formula (1) into a membrane state and bringing the molding into contact with a sulfonating agent to achieve sulfonation: 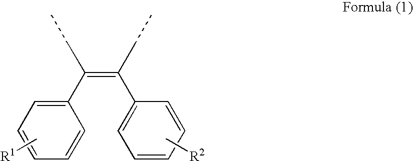
wherein either one or all of R¹ and R² represent a silyl group represented by the following formula (2); and the remainder represents hydrogen, a hydroxyl group, an alkyl group or an alkoxy group each having from 1 to 8 carbon atoms, a t-butyldimethylsilyloxy group, an acetyloxy group, or a group represented by the following formula (3): 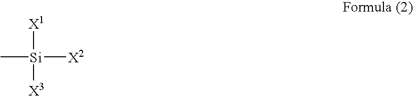
wherein X¹, X² and X³ each independently represents a linear or branched alkyl group having from 1 to 6 carbon atoms, and 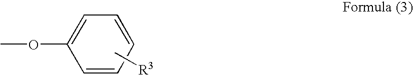
wherein R³ represents hydrogen, a hydroxyl group, an alkyl group or an alkoxy group each having from 1 to 8 carbon atoms, a trimethylsilyl group, a t-butyldimethylsilyloxy group, an acetyloxy group, or a group represented by the formula (2).

2. The process of producing a sulfonic group-containing substituted polyacetylene membrane according to claim 1, wherein the sulfonating agent is any one member selected from concentrated sulfuric acid, a mixed solution of concentrated sulfuric acid and a solvent, fuming sulfuric acid, sulfur trioxide-dioxane, sulfur trioxide-pyridine, chlorosulfonic acid, and sulfurous acid, or a combination of a plurality thereof.

3. A sulfonic group-containing substituted polyacetylene membrane which is the sulfonic group-containing substituted polyacetylene membrane produced by the production process according to claim 1, wherein the sulfonic group is uniformly distributed in a membrane thickness direction.

4. A substituted polyacetylene membrane/electrode assembly comprising the sulfonic group-containing substituted polyacetylene membrane according to claim 3 having an electrode imparted thereto.

5. An electrochemical device comprising the substituted polyacetylene membrane/electrode assembly according to claim 4.

6. A fuel cell comprising the substituted polyacetylene membrane/electrode assembly according to claim 4.

7. A sulfonic group-containing substituted polyacetylene membrane which is the sulfonic group-containing substituted polyacetylene membrane produced by the production process according to claim 2, wherein the sulfonic group is uniformly distributed in a membrane thickness direction.

8. A substituted polyacetylene membrane/electrode assembly comprising the sulfonic group-containing substituted polyacetylene membrane according to claim 7 having an electrode imparted thereto.

9. An electrochemical device comprising the substituted polyacetylene membrane/electrode assembly according to claim 7.

10. A fuel cell comprising the substituted polyacetylene membrane/electrode assembly according to claim 7.
